(19) United States
(12) Patent Application Publication
(10) Pub. No.: US 2009/0197220 A1
(43) Pub. Date: Aug. 6, 2009

(54) ORAL CLEANING DEVICE AND METHOD OF USE

(76) Inventor: Chris Cindrich, Draper, UT (US)

Correspondence Address: HOLMAN IP LAW, 175 S Main Street, Suite #850, Salt Lake City, UT, 84111, US

(21) Appl. No.: 12/367,167

(22) Filed: Feb. 6, 2009

Related U.S. Application Data
(60) Provisional application No. 61/026,683, filed on Feb. 6, 2008.

(51) Int. Cl. A61C 17/00; A46B 9/04

(52) U.S. Cl. 433/216; 15/167.1; 433/89

(57) ABSTRACT

An oral cleaning device is described. The oral cleaning device includes a brush head, a stem, a suction adapter, and a supply reservoir. The brush head includes a cleaning surface and defines an internal cavity. The stem is coupled to the brush head. The stem includes a fluid channel for bi-directional fluid flow to dispense fluid out of the brush head and to suction fluid into the brush head. The suction adapter is to the stem. The suction adapter couples a suction device to the stem for providing a suction flow within the stem in response to control by a user. The supply reservoir includes an integrated supply adapter to couple the supply reservoir to the suction adapter. The supply reservoir contains a water-based cleaning solution with less than a prescription amount of a cleaning agent.

### CROSS-REFERENCE TO RELATED APPLICATIONS

This application claims the benefit of U.S. Provisional Application No. 61/026,683, filed on Feb. 6, 2008, entitled “ORAL CLEANING DEVICE AND METHOD OF USE,” which is incorporated by reference herein in its entirety.

### BACKGROUND

Healthcare facilities commonly implement Ventilator Associated Pneumonia (VAP) prevention “Bundles” (essentially a collection of best practice measures to reduce the potential for pneumonia for mechanically ventilated patients) in the Intensive Care Units (ICU's) to reduce the incidence of VAP and are doing so with documented success. A common component of these bundles is regularly scheduled oral care ranging from 1 to 12 or more times per day. One chemical antimicrobial agent for VAP prevention oral care is chlorhexidine, a bactericidal that is effective against both gram positive and gram negative bacteria.

Today, clinicians commonly collect the individual components they need to perform VAP prevention oral care, or they use pre-packaged kits containing the components. Common oral components include: chemical cleaning solution(s), toothbrush and/or swab(s), cleaning solution reservoir(s), suction tube, and a mouth moisturizer. Current packaging configurations of a leading cleaning solution kit require that the solution be poured into a fluid reservoir, and the cleaning swab or toothbrush is then dipped into the reservoir during the oral care procedure. Using this conventional procedure, multiple process tools are used and discarded during the sequential steps.

Many clinicians consider VAP prevention oral care to be a difficult task to perform and that the difficulty of the task can increase process variability, thus causing the procedure to often be less effective than intended. Much of the difficulty in providing thorough and effective oral care stems from the design of the oral devices themselves. While intended to look and function much like a toothbrush, a deviation from “normal” tooth-brushing is apparent in the intermittent movement to “dip” or otherwise coat the end of the device repeatedly in the cleaning agent. The agent, as discussed above, is conventionally dispensed into a rather unstable and flimsy open-top reservoir into which the user dips the end of the brush so as to coat the brush with the agent. It is easy to appreciate how messy and time consuming this can be. When tasks are difficult to perform, for any of a number of reasons, the quality of performing the task usually decreases. In this case the impact of poor oral care leads to a higher risk for VAP which, if acquired, results in longer duration of hospital stay, higher cost of care and ultimately a higher risk for mortality.

Additionally, conventional VAP prevention oral care relies on the use of a chemical antimicrobial agent, chlorhexidine gluconate (CHG). CHG solutions at 0.12% concentration are classified as prescription drug products. Hence, physicians must provide prescriptions for oral care when CHG is used, and the drug is controlled and distributed through a pharmacy. While these controls are typical for prescription drug products, the use of prescription grade CHG in conventional VAP prevention oral care involves administrative procedures that make it more difficult to provide VAP prevention oral care.

Also, conventional VAP chemical cleaning solutions, both with and without CHG, typically contain about 11.6% alcohol. The alcohol content can irritate oral lesions, exacerbate conditions such as mucosal hypersensitivity or xerostomia, and is not appropriate for patients who have undergone head and neck surgery. Additionally, the alcohol content can be detrimental for patients who are immunocompromised or alcohol sensitive, can contribute to the breakdown of dental materials, and is flammable.

### SUMMARY

There are is an opportunity to improve conventional oral care processes by increasing the simplicity and overall usability of the oral care device, while reducing variability in the process. This results in a better VAP prevention and improved patient outcomes overall. In one embodiment, an oral care cleaning device includes both any cleaning tool (a brush or swab) and a chemical antimicrobial agent in one unit. Combining the chemical antimicrobial agent with the cleaning tool decreases the complexity of the task by not requiring repeated “dipping” or coating of the brush or swab. The combination also reduces the perception of messiness associated with oral care by containing the agent more suitably. The combination also lowers overall costs associated with the device by reducing material usage and waste. Conventionally, waste results from spillage, as well as material being discarded when the procedure is complete.

Furthermore, embodiments of the device may allow the clinician to dispense the antimicrobial agent on-demand and in such a way that the cleaning tool is substantially covered with or wetted by the antimicrobial agent. At least one design includes putting the cleaning agent in the handle of the device, or forming at least a portion of the handle with the actual packaging of the cleaning agent. Additionally, an embodiment of a method for dispensing the agent includes a squeezing the aforementioned handle as a means of dispensing the agent. The device suitable for containing the cleaning agent may include a valve, seal, or other structured mechanism to contain the cleaning agent prior to use. However, it should also be easy to open, puncture, or otherwise overcome on-demand. The on-demand dispensing of the antimicrobial agent could be either a one-time release or an intermittent release, at the control of the user.

In some embodiments, the device also incorporates on-demand suction via direct attachment of the device to the hospitals central vacuum system. This suction could be implemented by a suction device suited for attachment to a length of tubing that would be common to the wall suction (i.e., the vacuum suction originating on a wall of the hospital room). A switch or other manual control allows the vacuum suction to be turned on and off by the device user. Adding such functionality may improve overall usability of the device by allowing users to, in essence, dispense, clean, and evacuate all with one device and with a minimum amount of setup and manipulation. In one embodiment, the suction orifice is distally located on the device. The orifice may be exposed at all times or may become exposed via extension of the orifice and/or retraction or removal of the cleansing tool head from the distal end of the device, once brushing and/or swabbing is complete.

In some embodiments, a mouth moisturizer may be applied to the oral cavity after the cleaning operations are complete. Conventional kits typically include a separate reservoir of moisturizing material and means to apply or distribute the moisturizer to the surfaces of the oral cavity. However, the application of the mouth moisturizer may be eliminated, in some embodiments, by using a non-alcohol based cleaning solution. Using a non-alcohol-based cleaning solution reduces drying out of the mucosa of the oral cavity and reduces, or possibly eliminates, the need for an auxiliary oral moisturizer. In embodiments which include an oral moisturizer, the mouth moisturizing agent may be included in the antimicrobial solution itself. In some embodiments, the mouth moisturizer agent includes ingredients such as vitamin E and/or coconut oil.

A complicating factor in the design of a device intended to increase usability and improve patient outcomes is that the most common antimicrobial agent used for VAP prevention oral care contains approximately 0.12% chlorhexidine in an 11.6% alcohol/water solution. Since conventional antimicrobial agents are alcohol-based solutions, the packaging for the antimicrobial agent is typically glass or another material which inhibits the evaporation of the alcohol. However, glass enclosures are potentially unsafe.

In one embodiment, an antimicrobial agent other than an alcohol-based solution may be used. For example, a water-soluble chlorhexidine solution that does not contain alcohol may be used as an antimicrobial agent to allow for broader packaging material and design selections and, hence, lower overall costs. One example of a water soluble chlorhexidine solution is the recently NDA approved GUM water based 0.12% CHG solution available from Sunstar Americas, Inc. (http://www.jbutler.com).

An alternative approach to the packaging design is to design the device for use with an alcohol-containing solution by incorporating into the design a reservoir that is impermeable to alcohol. This may be done through use of either a foil pouch or a glass ampoule that contain the solution. The alcohol-based antimicrobial agent may be preserved in the foil pouch or glass ampoule until the clinician activates the device, either by puncturing the pouch, breaking the ampoule, or otherwise opening the reservoir.

In light of these foregoing considerations, embodiments of an apparatus are described. In one embodiment, the apparatus is an oral cleaning device. The oral cleaning device includes a brush head, a stem, a suction adapter, and a supply reservoir. The brush head includes a cleaning surface and defines an internal cavity. The stem is coupled to the brush head. The stem includes a fluid channel for bidirectional fluid flow to dispense fluid out of the brush head and to suction fluid into the brush head. The suction adapter is coupled to the stem. The suction adapter couples a suction device to the stem for providing a suction flow within the stem in response to control by a user. The supply reservoir has an integrated supply adapter to couple the supply reservoir to the suction adapter. The supply reservoir includes a water-based cleaning solution with less than a prescription amount of a cleaning agent. Other embodiments of the oral cleaning device are also described.

Embodiments of a method for using a disposable oral cleaning device are also described. In one embodiment, the method includes attaching a suction tube to a suction port of a suction adapter. The suction adapter allows controlled suction from a suction source coupled to a distal end of the suction tube. The suction adapter is configured to be coupled to a stem and a brush head at a stem port of the suction adapter, and the suction adapter is configured to be coupled to a supply reservoir at a supply port of the suction adapter. The method also includes dispensing lavage fluid from the supply reservoir to the brush head, through a first fluid path of the suction adapter and a fluid channel within the stem, for lavage of an oral cavity. The method also includes suctioning fluids from the oral cavity, through a second fluid path of the suction adapter and the same fluid channel within the stem, to aspirate the oral cavity. The method also includes detaching the suction tube from the suction port of the suction adapter in response to completion of cleaning the oral cavity. The method also includes disposing of the disposable oral cleaning device, including the suction adapter, the stem, and the brush head. Other embodiments of the method are also described.

Embodiments of a supply reservoir for an oral cleaning device are also described. In one embodiment, the supply reservoir includes a sealed proximal end, a supply adapter at a distal end of the supply reservoir, and a pre-dosed amount of oral cleaning solution. The sealed proximal end is to prevent fluid egress out of the sealed proximal end. The supply adapter includes a sealed internal valve to prevent fluid egress out of the distal end. The supply adapter also includes an external force beyond a threshold on the internal valve causes the sealed internal valve to at least partially open. The supply adapter also includes an internal rib to facilitate coupling to another component of the oral cleaning device. The pre-dosed amount of oral cleaning solution is disposed within a fluid cavity between the sealed proximal end and the sealed internal valve of the supply adapter. Other embodiments of the supply reservoir are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIGS. 1-3 depicts different perspective views of one embodiment of an oral cleaning device designated for use in reducing the bacterial load in the oral cavity.

FIG. 4 depicts an exploded perspective view of the oral cleaning device shown in FIGS. 1-3.

FIG. 5 depicts another perspective view of the oral cleaning device shown in FIGS. 1-3.

FIG. 6 depicts another exploded perspective view of the oral cleaning device shown in FIGS. 4 and 5.

FIGS. 7 and 8 depict perspective cross-sectional views of a specific embodiment of a supply reservoir.

FIG. 9 depicts a more detailed perspective cross-sectional view of the internal valve of the supply reservoir shown in FIG. 8.

FIGS. 10-14 depict an embodiment of the oral cleaning device in various stages of operation.

FIG. 15 depicts a schematic flow chart diagram of one embodiment of a method for using a disposable oral cleaning device such as the oral cleaning device shown in FIGS. 10-14.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments of an oral cleaning device are described herein, at least some of the described embodiments facilitate bidirectional fluid flow within a single fluid channel to perform both dispensing fluids out of the oral cleaning device and suctioning fluids into the oral cleaning device. Also, certain embodiments use a crushable plastic ampoule valve to control and allow fluid flow of a cleaning agent through the fluid channel and into the oral cavity. Additionally, embodiments use a water-based cleaning solution that is substantially free of alcohol and contains less than a prescription amount of a cleaning agent such as CHG.

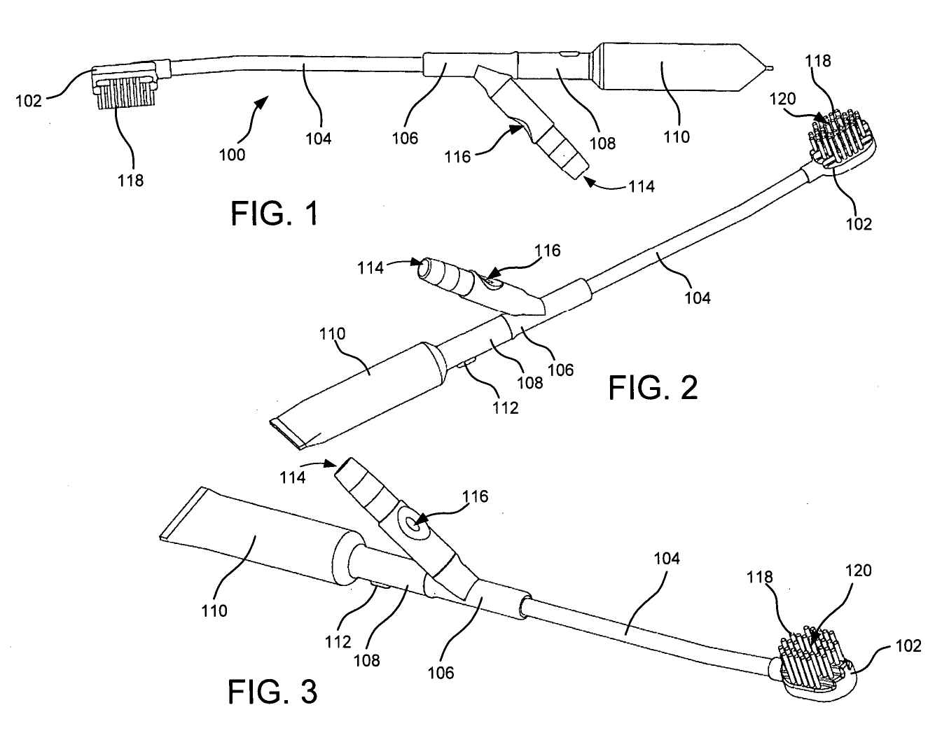

FIGS. 1-3 depict different perspective views of one embodiment of an oral cleaning device 100 designated for use in reducing the bacterial load in an oral cavity. Although the illustrated oral cleaning device 100 has the appearance and is described with certain functionality similar to a toothbrush, other embodiments may implement other components and/or functionality that are distinct from a conventional toothbrush.

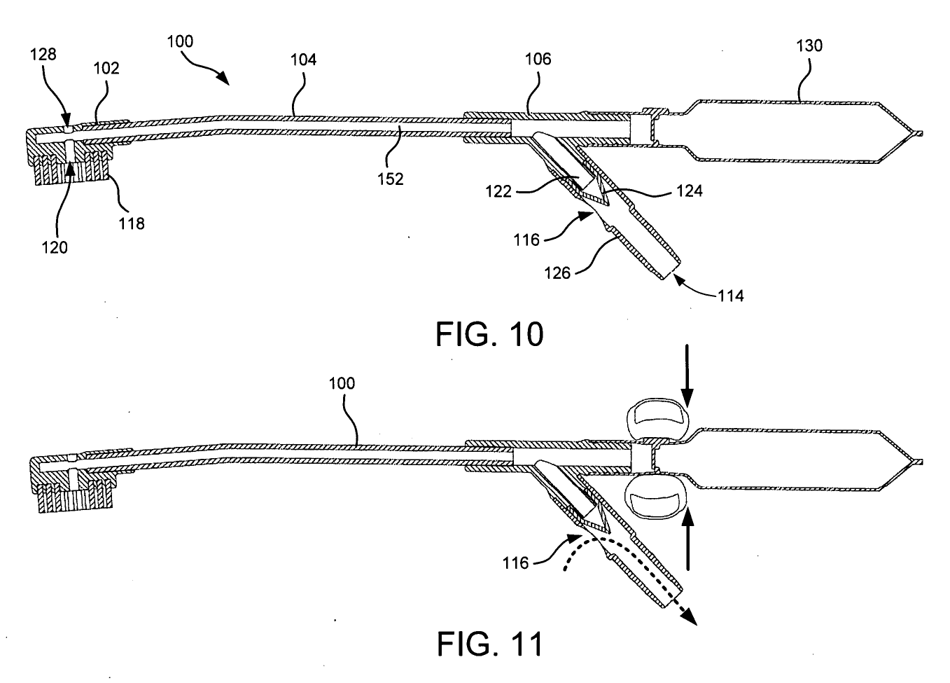

The illustrated oral cleaning device 100 includes a brush head 102 attached to a stem 104. The stem 104 defines a fluid channel therein (refer to FIG. 10 and the accompanying description below). In one embodiment, the stem 104 defines a single fluid channel, although other embodiments may implement multiple fluid channels within the stem 104. The stem 104 connects to the handle portion of the oral cleaning device 100.

The brush head 102 is substantially hollow inside to permit fluid communication with the stem 104 when the brush head 102 and stem 104 are connected to the handle portion. There are many potential configurations for the brush head 102. In one embodiment, the brush head is an “angle” brush head. In another embodiment, the brush is a foam swab. In another embodiment, the brush is a pipe cleaner style with bristles protruding substantially around the entire brush head. Other embodiments also may be implemented. In each of these embodiments of the brush head 102, the fluid from the supply reservoir 102 of the oral cleaning device 100 passes through the brush head 102 out into the oral cavity for use in oral care. As such, various head designs may have at least a partially hollow interior section suitable for the passage of such fluid, gel, foam, or other substance. Additionally, various embodiments can be implemented to include firm bristles or soft bristles or combinations of swab surfaces with bristles. For example, one embodiment combines a foam pad with bristles protruding through at least portions of the foam pad. In this embodiment, the foam pad may promote fluid retention, while the bristles facilitate scrubbing or cleaning surfaces within the oral cavity.

The illustrated handle portion of the oral cleaning device 100 includes a suction adapter 106, a supply adapter 108, and a supply reservoir 110. In general, the supply reservoir 110 holds a volume of fluid (e.g., liquid, gel, foam, or similar substance) for transfer to the brush head 102 through the supply adapter 108, the suction adapter 106, and the stem 104. In some embodiments, the supply adapter 108 is an integrated part of the supply reservoir 110.

The substance within the supply reservoir 110 includes an antimicrobial cleaning agent, which is described in more detail below. The supply reservoir 110 may be any type of rigid or flexible container to hold the antimicrobial cleaning agent, including pre-fabricated plastic, glass, or other types of ampoules. One example of a plastic ampoule is a 5 ml ampoule available from James Alexander Corporation in New Jersey.

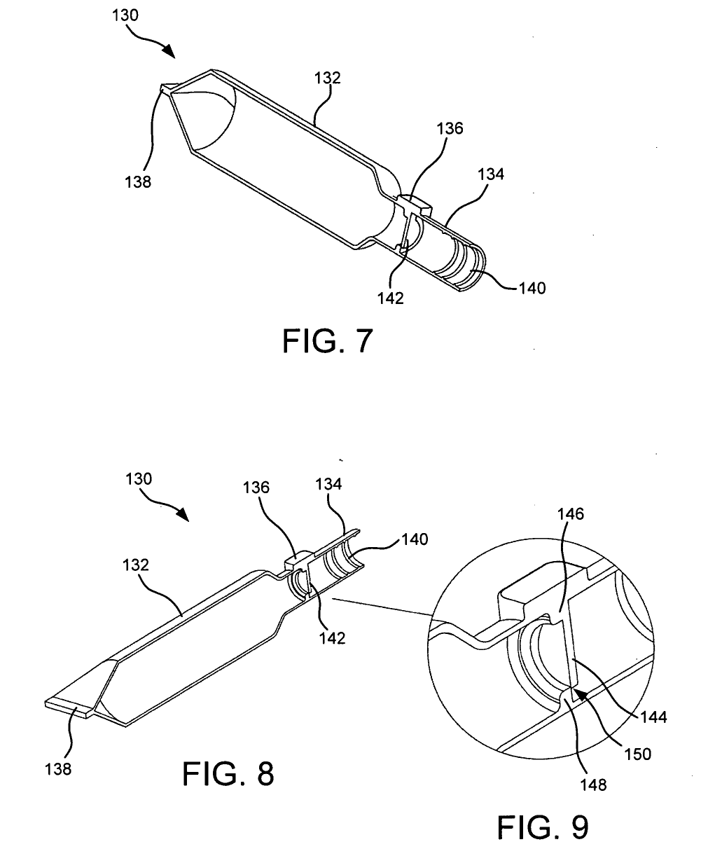

The supply adapter 108 includes an internal valve mechanism (refer to FIGS. 7-9 and the accompanying description below) to retain the fluid in the supply reservoir 110. The fluid flows through the supply adapter 108 once a user releases the fluid from the supply reservoir 110 into the stem 104. A valve controller 112 on the outside of the supply adapter 108 may function to control the internal valve and release the fluid from the supply reservoir 110. In some embodiments, the supply adapter 108 may be formed together with the supply reservoir 110 in an integrated design, for example, as described in U.S. Pat. No. 6,869,242 to May entitled “DISPENSER AND PROCESS” and issued on Mar. 22, 2005. Other embodiments may use other designs for the supply reservoir 110 and/or the supply adapter 108.

Upon release of the fluid from the supply reservoir 110, the fluid travels through the supply adapter 108, the suction adapter 106, and the stem 104 to the brush head 102. At the brush head 102, the fluid is released through one or more ports, or orifices. For example, the brush head 102 may include a port 120, or orifice, on the bristle side of the brush head 102 to allow the fluid to exit the oral cleaning device 100 from the brush head 102. Some embodiments may include one or more ports 128, or holes, on the back side of the brush head 102 (refer to FIGS. 5 and 6 and the accompanying description below). Likewise, the holes may be situated either on the end of the brush head 102 or anywhere along the stem 104, or shaft, leading to the brush head 102. Other embodiments may include one or more orifices in other locations of the brush head 102.

Thus, during a cleaning cycle of a patient's mouth, the fluid is released into the patient's mouth to facilitate brushing the patient's teeth, removing food and other particles, and killing harmful bacteria or germs. The brush head 102 includes bristles 118 and/or foam or other soft scrubbing materials (not shown) to facilitate scrubbing the patient's teeth, gums, or other surfaces within the patient's mouth.

In one embodiment, the suction adapter 106 includes a suction attachment port 114 to allow a suction tube (not shown) or other device to be attached to the oral cleaning device 100. In some embodiments, a user can control the suction applied to the brush head 102, for example, to remove fluids from the patient's mouth. The illustrated suction adapter 106 defines a suction control port 116 which is a hole in the sidewall of the suction adapter 106. When the suction control port 116 is uncovered, the suction from an external source causes airflow through the suction control port 116 and into the suction tube attached to the suction attachment port 114. Thus, the suction does not interrupt, or has insubstantial impact on, the fluid flow within the stem 104. However, when the suction control port 116 is covered, the suction from the external source causes suction in the stem 104 as well as the brush head 102, for example, to aspirate fluids from the oral cavity.

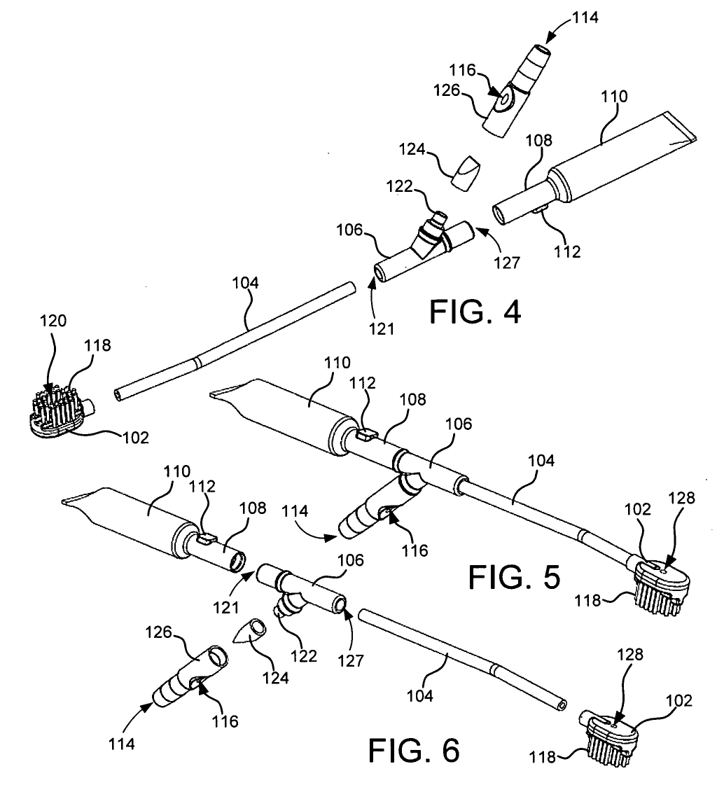

In one embodiment, the suction adapter 106 includes a Y-adapter with a duckbill valve (refer to FIGS. 4, 6, and 10-14 and the accompanying description below) or another type of valve to prevent suctioning of the liquid out of the supply reservoir 110. Alternatively, or in addition to the valve in the suction adapter 106, the supply adapter 108 may include a valve (refer to FIGS. 7-9 and the accompanying description below) to substantially prevent fluid flow out of the supply reservoir 110 based solely on a decrease in air pressure at the suction adapter 106.

FIG. 4 depicts an exploded perspective view of the oral cleaning device 100 shown in FIGS. 1-3. The illustrated components of the oral cleaning device 100 include the brush head 102 with the bristles 118 and the fluid port 120. The brush head 102 connects to an end of the stem 104. In some embodiments, the stem 104 may have an angled configuration, with a bend to angle the brush head 102 relative to the suction adapter 106 and the supply reservoir 110. Other embodiments may have a straight stem 104 or a stem 104 with another configuration.

The other end of the stem 104 connects to a stem port 121 of the suction adapter 106. The illustrated suction adapter 106 includes a valve seat 122 to position and support an internal valve 124. In one embodiment, the valve 124 is a duckbill valve, although other embodiments may use other types of one-way valves. In particular, the valve 124 allows flow away from the stem port 121 (as indicated by the adjacent arrow, but does not allow flow toward the stem port 121.

The suction adapter 106 also includes an attachment extension 126 with the suction control port 116 and the attachment port 114. In one embodiment, the attachment port 114 is a suction port to allow suction from an external suction tube connected to an external suction source (not shown). The suction from the suction source creates suction flow from the brush head 102 through the stem port 121 and the internal valve 124 and out of the suction port 114.

The suction adapter 106 also includes a supply port 127. The supply port 127 facilitates connection of the suction adapter 106 to the supply reservoir 110 via the supply adapter 108. The suction adapter 106 allows supply fluid flow from the supply reservoir 110 through the supply port 127 and the stem port 121 toward the brush head 102 of the oral cleaning device 100.

FIG. 5 depicts another perspective view of the oral cleaning device 100 shown in FIGS. 1-3. In particular, the illustrated embodiment shows a port 128, or hole, on the back side of the brush head 102. This port 128 can be used to facilitate delivery of the cleaning agent into the oral cavity. Additionally, this port 128 can be used to facilitate removal of fluids from the oral cavity. FIG. 6 depicts another exploded perspective view of the oral cleaning device 10 shown in FIGS. 4 and 5, which are described above.

FIGS. 7 and 8 depict perspective cross-sectional views of a specific embodiment of a supply reservoir 130. Aspects of the illustrated supply reservoir 130 are substantially similar to the supply reservoir 110 shown in the previous figures and described above. The illustrated supply reservoir 130 includes a fluid cavity 132 coupled to a fluid egress channel 134. The fluid cavity 132 is separated from the fluid egress channel 134 by a neck 136. The fluid can be maintained in the fluid cavity 132 between the neck 136 and a sealed proximal end 138 of the supply reservoir 130.

The fluid egress channel 134 includes one or more structural ribs, for example, to couple the supply reservoir 130 to the supply port 127 of the suction adapter 106. Other embodiments may use other mechanisms to connect and/or seal the supply reservoir 130 to the suction adapter 106.

In order to release the fluid from the fluid cavity 132 into the fluid egress channel 134, the supply reservoir 130 includes an internal valve 142 at the neck 136. FIG. 9 depicts a more detailed perspective cross-sectional view of the internal valve 142 of the supply reservoir 130 shown in FIG. 8. In particular, the valve 142 includes a flap 144 that is sturdily connected to a structural portion 146 of the sidewall within the neck 136. The valve 142 also includes a structural stopping portion 148 that circumscribes a substantial portion of the sidewall within the neck 136. When the flap 144 is seated against the structural stopping portion 148, the valve 142 is closed. When the valve 144 is not seated against the structural stopping portion 148, the valve 142 is open. In some embodiment, the valve 142 may be fabricated with a seal 150 between the flap 144 and the structural stopping portion 148, so that no fluid escapes from the fluid cavity 132. A user may initially activate the valve 142 by applying external pressure on the neck 136 of the supply reservoir 130, so that the external pressure breaks the seal 150 between the flap 144 and the structural stopping portion 148. Once the seal 150 is broken, the flap 144 may continue to rest against the structural stopping portion 148, so that no fluid (or insubstantial amounts of fluid) is released from the fluid cavity 132. Upon application of external pressure on the neck 136 and/or the fluid cavity 132, the flap 144 may separate from the structural stopping portion 148 enough to allow fluid to flow out of the fluid cavity 132 and into the fluid egress channel 134. Upon termination of such external pressure, the flap 144 returns to its seated position against the structural stopping portion 142, thus substantially stopping the flow of fluid out of the fluid cavity 132. The continuing structural connection between the flap 144 and the structural portion 146 may create sufficient resilience to return the flap 144 to the seated position against the structural stopping portion 148. Other embodiments may use other types of valves 142.

FIGS. 10-14 depict an embodiment of the oral cleaning device 100 in various stages of operation. A possible sequence of use for an embodiment of this oral cleaning device 100 includes a user removing the device from its package. FIG. 10 illustrates a cross-sectional view of one embodiment of the oral cleaning device 100. In particular, this illustration shows the internal fluid cavity 152 within the stem 104 of the oral cleaning device 100. As described herein, the fluid cavity facilitates bidirectional fluid flow for both supplying cleaning solution from the supply reservoir 130 to the brush head 102, and for suction fluids from the oral cavity through the brush head 102 and out of the suction port 114 of the suction adapter 106.

After removing the oral cleaning device 100 from the packaging, a user then pinches, breaks, or otherwise disrupts the valve 142 in the supply adapter 108 to create a fluid communication from the supply reservoir 110 to the brush head 102. FIG. 11 shows one embodiment of an operation to initially open the valve 142 within the supply reservoir 130, using external force at the neck 136 (in the directions shown by the solid arrows). It should be noted that, at this stage, the one-way valve 124 within suction adapter 106 is closed, so suction flows through the suction control port 116 (as indicated by the dashed arrow), rather than through the stem 104 and the brush head 102.

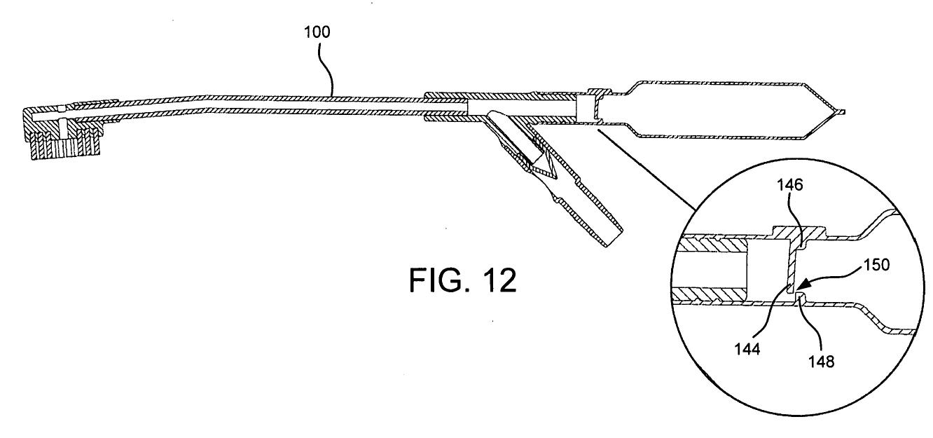

FIG. 12 shows a more detailed embodiment of the valve 142 after the user initially breaks the seal 150 between the flap 144 and the structural stopping portion 148. As noted above, the flap 144 is connected to the structural portion 146 so that the flap 144 can resiliently return to the closed position in the absence of internal pressure to release the fluid from the fluid cavity 132.

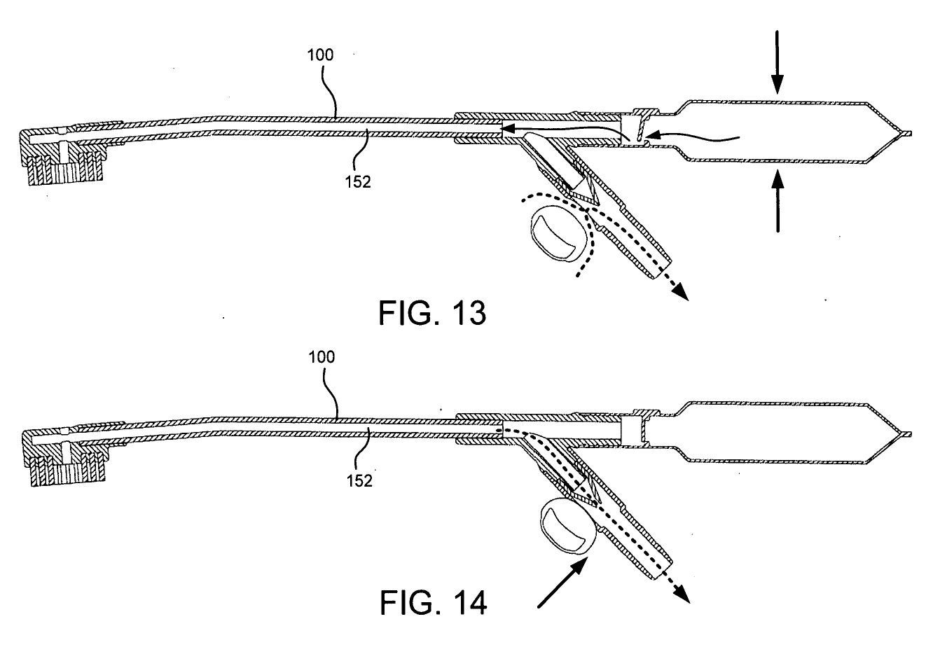

FIG. 13 shows one embodiment of fluid exiting the fluid reservoir 132, for example, to clean the oral cavity of a patient. The user squeezes the supply reservoir 130 once, or multiple times, (with external pressure in the directions indicated by the solid arrows) in order to allow or force the fluid to be evacuated from the supply reservoir 130 to the brush head 102 and out into the oral cavity. At this stage, similar to the stage depicted in FIG. 11, the suction flows through the suction control port 116 (as indicated by the dashed arrow), rather than through the stem 104 and the brush head 102.

FIG. 14 shows one embodiment of an operation to use the oral cleaning device 100 for suctioning fluids from the oral cavity of a patient. In order to direct the suction through the stem 104 and the brush head 102, the user can obstruct the suction control port 116 by placing a finger over the suction control port 116. Alternatively, the suction control port 116 may be obstructed by another device such as a closure plate, a corking device, and so forth. When the suction control port 116 is obstructed, the suction within the attachment extension 126 opens the one-way valve 124 within the suction adapter 106 to create a suction flow (as indicated by the dashed arrow) that draws fluids out of the oral cavity through the brush head 102 and fluid channel within the stem 104.

The operations of dispensing fluid to clean the oral cavity and suctioning fluids out of the oral cavity may be combined in various ways and/or repeated a number of times. Upon completion of the oral cleaning routine, the oral cleaning device 100 may be discarded, in its entirety. Hence, the suction tube may be removed from the suction port 114 of the suction adapter 106, and the oral cleaning device 100 may be discarded, including the brush head 102, the stem 104, the suction adapter 106, and the supply reservoir 130. In some embodiments, it may be possibly to at least partially disassemble the oral cleaning device 100 prior to disposal of the oral cleaning device 100.

In some embodiments, the brush head 102 and the stem 104 are separate pieces manufactured discreetly from the suction adapter 106, the supply adapter 108, and the supply reservoir 110. The brush head 102 and stem 104 then may be snapped on, or otherwise connected, to the suction adapter 106 as a part of the manufacturing process or, alternatively, during on-site assembly of the oral cleaning device 100. One potential advantage to an embodiment which uses separately manufactured brush heads 102 is the ability to allow the manufacturer to make a single supply reservoir 110 and, depending on the application, put a specific brush head 102 onto the supply reservoir 110, according to customer needs and applications.

Embodiments which use the suction adapter 106 to couple the stem 104 to the supply adapter 108 facilitate aspiration using the same device that is used for cleaning. In other words, the brush head 102 has the ability to be attached to suction and to be configured for use as a suction device, either during or following the regular oral cleaning protocol. In some embodiments, the brush head 102 is ejected or otherwise removed from the end of the stem 104 when the user is done with the brushing routine, leaving behind a hollow shaft suitable for aspiration of fluids from the oral cavity. The open end of the stem 104 may be configured to be suitable to the unique needs of providing safe and effective suctioning. Thus, embodiments of the stem 104 may incorporate features to prevent abject plugging or clogging of the distal tip of the device. Additionally, the stem 104 may be soft and non injurious in terms of its shape and materials. Some embodiments also include depth gauge markings that indicate the depth of the stem 104 within the oral cavity.

Alternatively, the brush head 102 may be retained, and suction may occur in the presence of the brush head 102. In other embodiments, all or part of the brush head 102 may be retracted into a cavity of the stem 104, other than the fluid channel, so that the brush head 102 does not obstruct the aspiration procedure. In this manner, the brush is available for brushing when the suction is disabled, but the brush head may be retracted so that suction can be initiated and effective evacuation of the oral cavity can begin after brushing is completed. A potential advantage of this embodiment is the ability to promote both cleaning and suctioning and, hence, reduce the time to set up and use the device.

In regard to the antimicrobial chemical cleaning solution, some embodiments use a water-based CHG solution, rather than an alcohol-based CHG solution. Using a water-based CHG solution allows usage of preservative levels of CHG, which are lower prescription levels and, hence, do not necessarily require distribution through pharmaceutical channels. Also, water-based CHG antimicrobial chemical solutions can improve patient comfort when compared with alcohol-based solutions that irritate and/or dry out the tissues in the oral cavity. In further embodiments, some forms of the water-based CHG antimicrobial chemical solutions may include taste-enhancing, viscosity, anti-staining, and/or other additives.

Some embodiments also provide improved simplicity and reduced waste from discarded devices. In contrast, conventional devices which are currently designed for this purpose, but which do not have retractable or otherwise removable brush heads implement suctioning through the somewhat bulky brush itself. This may make effective evacuation of the oral cavity difficult because reaching small spaces in the oral cavity is difficult when a relatively large brush head is attached to the end of the suctioning device.

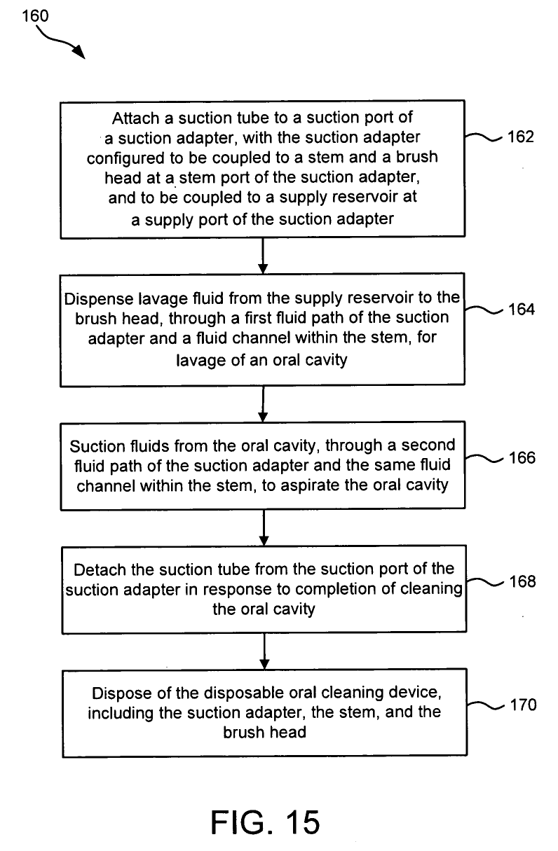

FIG. 15 depicts a schematic flow chart diagram of one embodiment of a method 160 for using a disposable oral cleaning device 100 such as the oral cleaning device 100 shown in FIGS. 10-14. Although the illustrated method 160 is described in conjunction with the oral cleaning device 100 of FIGS. 10-14, other embodiments of the method 160 may be implemented with other types of oral cleaning device 100.

In the illustrated method 160, a suction tube is attached 162 to the suction port 114 of the suction adapter 106. As explained above, the suction adapter 106 is also configured to be attached to the stem 104 and the brush head 102 at the stem port 121, and to be attached to the supply reservoir 130 at the supply port 127. After the suction tube is attached to the suction adapter 106, a user may dispense 164 lavage fluid (i.e., the cleaning solution) from the supply reservoir 130 to the brush head 102. The lavage fluid substantially travels through a first fluid path through the suction adapter 106, from the supply port 127 to the stem port 121. The lavage fluid then travels through the fluid channel 152 of the stem 104 and the brush head 102 for cleaning the oral cavity.

After dispending lavage fluid into the oral cavity, the user may suction 166 fluids from the oral cavity through the brush head 102 and the same fluid channel 152 in the stem 104. The suctioned fluids substantially travel through a second fluid path in the suction adapter 106, from the stem port 121 to the suction port 114.

After cleaning of the oral cavity is complete, the user detaches 168 the suction tube from the suction port 114 of the suction adapter 106. The user then discards 170 the entire disposable oral cleaning device 100, including the suction adapter 106, the stem 104, and the brush head 102. Also, the user may dispose of the supply reservoir 130 at the same time, with or without removing the supply reservoir 130 from the supply port 127 of the suction adapter 106. The illustrated method 160 then ends.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. An oral cleaning device comprising:
a brush head comprising a cleaning surface and defining an internal cavity;
a stem coupled to the brush head, the stem comprising a fluid channel for bi-directional fluid flow to dispense fluid out of the brush head and to suction fluid into the brush head;
a suction adapter coupled to the stem, the suction adapter to couple a suction device to the stem for providing a suction flow within the stem in response to control by a user; and
a supply reservoir with an integrated supply adapter to couple the supply reservoir to the suction adapter, wherein the supply reservoir comprises a water-based cleaning solution with less than a prescription amount of a cleaning agent.

2. The oral cleaning device of claim 1, wherein the supply adapter integrated with the supply reservoir comprises a crushable valve to control fluid flow of the water-based cleaning solution out of the supply reservoir.

3. The oral cleaning device of claim 1, wherein the brush head comprises a combination of a foam pad for retention of liquids and bristles extending through at least a portion of the foam pad for cleaning an oral cavity.

4. The oral cleaning device of claim 1, wherein the suction adapter comprises a Y-adapter with a duckbill valve to limit suction flow on the water-based cleaning solution within the supply reservoir.

5. The oral cleaning device of claim 1, further comprising a suction control port in the form of a hole in a sidewall of the suction adapter, wherein the suction control port is configured to allow a user to block suction flow through the suction control port in order to direct suction flow through the fluid channel of the stem and the brush head.

6. The oral cleaning device of claim 1, wherein the water-based cleaning solution comprises a liquid.

7. The oral cleaning device of claim 1, wherein the water-based cleaning solution comprises a gel.

8. The oral cleaning device of claim 1, wherein the water-based cleaning solution comprises a foam.

9. The oral cleaning device of claim 1, wherein the water-based cleaning solution is substantially free of alcohol.

10. The oral cleaning device of claim 1, wherein the cleaning agent comprises chlorhexidine gluconate (CHG).

11. The oral cleaning device of claim 10, wherein the water-based cleaning solution comprises less than about 0.12% concentration of CHG.

12. The oral cleaning device of claim 1, wherein the suction adapter is disposable with the stem and the brush head.

13. A method for using a disposable oral cleaning device, the method comprising:
attaching a suction tube to a suction port of a suction adapter, the suction adapter to allow controlled suction from a suction source coupled to a distal end of the suction tube, wherein the suction adapter is configured to be coupled to a stem and a brush head at a stem port of the suction adapter, and the suction adapter is configured to be coupled to a supply reservoir at a supply port of the suction adapter;
dispensing lavage fluid from the supply reservoir to the brush head, through a first fluid path of the suction adapter and a fluid channel within the stem, for lavage of an oral cavity;
suctioning fluids from the oral cavity, through a second fluid path of the suction adapter and the same fluid channel within the stem, to aspirate the oral cavity;
detaching the suction tube from the suction port of the suction adapter in response to completion of cleaning the oral cavity; and
disposing of the disposable oral cleaning device, including the suction adapter, the stem, and the brush head.

14. The method of claim 13, further comprising:
attaching an integrated supply adapter of the supply reservoir to the supply port of the suction adapter, wherein the supply adapter comprises a valve to substantially control fluid flow of the lavage fluid out of the supply reservoir; and
disposing of the supply reservoir with the suction adapter, the stem, and the brush head.

15. The method of claim 13, wherein suctioning the fluids from the oral cavity, through the second fluid path of the suction adapter and the same fluid channel within the stem, to aspirate the oral cavity further comprising suctioning through a one-way valve within the second fluid path of the suction adapter in response to blockage of a suction control port.

16. The method of claim 13, further comprising:
dispensing the lavage fluid out of the brush head and into the oral cavity through an orifice in the brush head; and
suctioning the fluids out of the oral cavity and into the brush head through the same orifice in the brush head.

17. The method of claim 13, wherein dispensing lavage fluid from the supply reservoir further comprises dispensing a cleaning agent substantially free of alcohol and comprising less than about 0.12% concentration of chlorhexidine gluconate (CHG).

18. The method of claim 13, further comprising brushing a surface within the oral cavity with the brush head, wherein the brush head comprises a combination of a foam pad for retention of liquids and bristles extending through at least a portion of the foam pad.

19. A supply reservoir for an oral cleaning device, the supply reservoir comprising:
a sealed proximal end to prevent fluid egress out of the sealed proximal end;
a supply adapter at a distal end of the supply reservoir, the supply adapter comprising:
a sealed internal valve to prevent fluid egress out of the distal end, wherein an external force beyond a threshold on the internal valve causes the sealed internal valve to at least partially open; and
an internal rib to facilitate coupling to another component of the oral cleaning device; and
a pre-dosed amount of oral cleaning solution disposed within a fluid cavity between the sealed proximal end and the sealed internal valve of the supply adapter.

20. The supply reservoir of claim 19, wherein the oral cleaning solution comprises a cleaning agent substantially free of alcohol and comprising less than about 0.12% concentration of chlorhexidine gluconate (CHG).
